(19) United States
(12) Patent Application Publication
(10) Pub. No.: US 2008/0020999 A1
(43) Pub. Date: Jan. 24, 2008

(54) Fungicidal Mixtures Of Amidinylphenyl Compounds

(76) Inventors: Michael Caldwell Klapproth, Galena, MD (US); Chi-Ping Tseng, Wilmington, DE (US)

Correspondence Address: E.I.Du Pont De Nemours and Company;Legal Patent Records Center, 4417 Lancaster Pike, Wilmington, DE, 19805, US

(21) Appl. No.: 11/628,409

(22) PCT Filed: Jun. 1, 2005
(86) PCT No.: PCT/US05/19376

§ 371 Date: Dec. 1, 2006

Related U.S. Application Data
(60) Provisional application No. 60/576,780, filed on Jun. 3, 2004.

(51) Int. Cl. A01N 37/52; A01N 55/10; A01P 3/00

(52) U.S. Cl. 514/63; 514/637

(57) ABSTRACT

Disclosed are fungicidal mixtures, compositions and methods for controlling plant diseases relating to combinations comprising (a) at least one compound selected from phenylamidines of Formula I, N-oxides, and agriculturally suitable salts thereof (I) wherein A is C₃alkylene, optionally substituted with one or two methyl; W is CR⁵R⁶R⁷ or SiR⁸R⁹R¹⁰; and R¹, R², R³, R⁴, R⁵, R⁶, R⁷, R⁸, R⁹ and R¹⁰ are as defined in the disclosure; and (b) at least one compound selected from alkylenebis(dithiocarbamate) fungicides, compounds acting at the bc₁ complex of the fungal mitochondrial respiratory electron transfer site, cymoxanil, compounds acting at the demethylase enzyme of the sterol biosynthesis pathway, morpholine and piperidine compounds that act on the sterol biosynthesis pathway, phenylamide fungicides, pyrimidinone fungicides, chlorothalonil, carboxamides acting at complex II of the fungal mitochondrial respiratory electron transfer site, quinoxyfen, metrafenone, cyflufenamid, cyprodinil, copper compounds, phthalimide fungicides, fosetyl-aluminum, benzimidazole fungicides, cyazofamid, fluazinam, iprovalicarb, propamocarb, validamycin, dichlorophenyl dicarboximide fungicides, zoxamide and dimethomorph, and their agriculturally suitable salts.

### FIELD OF THE INVENTION

This invention relates to fungicidal mixtures of certain phenylamidines, their N-oxides, and/or agriculturally suitable salts thereof, and to compositions comprising such mixtures and methods for using such mixtures as fungicides.

### BACKGROUND OF THE INVENTION

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes, but the need continues for new mixtures and compositions that are more effective, less costly, less toxic, environmentally safer or have different modes of action.

Fungicides that effectively control plant fungi are in constant demand by growers. Combinations of fungicides are often used to facilitate disease control and to retard resistance development. It is desirable to enhance the activity spectrum and the efficacy of disease control by using mixtures of active ingredients that provide a combination of curative, systemic and preventative control of plant pathogens. Also desirable are combinations that provide greater residual control to allow for extended spray intervals. It is also very desirable to combine fungicidal agents that inhibit different biochemical pathways in the fungal pathogens to retard development of resistance to any one particular plant disease control agent.

Being able to reduce the quantity of chemical agents released in the environment while ensuring effective protection of crops from diseases caused by plant pathogens is always desirable. Mixtures of fungicides may provide significantly better disease control than could be predicted based on the activity of the individual components. This synergism has been described as “the cooperative action of two components of a mixture, such that the total effect is greater or more prolonged than the sum of the effects of the two (or more) taken independently” (see P. M. L. Tames, Neth. J. Plant Pathology 1964, 70, 73-80).

New fungicidal agents that are particularly advantageous in achieving one or more of the preceding objectives continue to be needed.

World Patent Application Publication WO 2003/093224 discloses certain phenylamidines of Formula i as new fungicidal active ingredients.

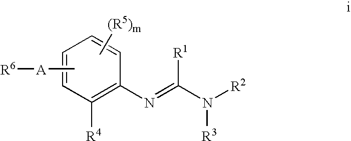

### SUMMARY OF THE INVENTION

This invention relates to a fungicidal mixture comprising (a) at least one compound selected from the phenylamidines of Formula I (including all geometric and stereoisomers), N-oxides, and agriculturally suitable salts thereof 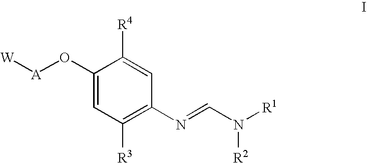
wherein
R¹ is C₁-C₂ alkyl;
R² is C₁-C₃ alkyl or cyclopropyl;
R³ is hydrogen, C₁-C₂ alkyl or halogen;
R⁴ is C₁-C₂ alkyl, C₁-C₂ haloalkyl, methoxy, halomethoxy, C₁-C₂ alkylthio, C₁-C₂ alkylsulfinyl, C₁-C₂ alkylsulfonyl or halogen;
A is C₃ alkylene, optionally substituted with one or two methyl;
W is CR⁵R⁶R⁷ or SiR⁸R⁹R¹⁰;
R⁵ is hydrogen or C₁-C₃ alkyl optionally substituted with halogen; and
each R⁶, R⁷, R⁸, R⁹ and R¹⁰ is independently C₁-C₃ alkyl optionally substituted with halogen; and
   (b) at least one compound selected from the group consisting of
(b1) alkylenebis(dithiocarbamate) fungicides;
(b2) compounds acting at the bc₁ complex of the fungal mitochondrial respiratory electron transfer site;
(b3) cymoxanil;
(b4) compounds acting at the demethylase enzyme of the sterol biosynthesis pathway;
(b5) morpholine and piperidine compounds that act on the sterol biosynthesis pathway;
(b6) phenylamide fungicides;
(b7) pyrimidinone fungicides;
(b8) chlorothalonil;
(b9) carboxamides acting at complex II of the fungal mitochondrial respiratory electron transfer site;
(b10) quinoxyfen;
(b11) metrafenone;
(b12) cyflufenamid;
(b13) cyprodinil;
(b14) copper compounds;
(b15) phthalimide fungicides;
(b16) fosetyl-aluminum;
(b17) benzimidazole fungicides;
(b18) cyazofamid;
(b19) fluazinam;
(b20) iprovalicarb;
(b21) propamocarb;
(b22) validamycin;
(b23) dichlorophenyl dicarboximide fungicides;
(b24) zoxamide; and
(b25) dimethomorph; and
agriculturally suitable salts of compounds of (b1) through (b25).

This invention also relates to a fungicidal composition comprising a fungicidally effective amount of a mixture of the invention and at least one additional component selected from the group consisting of surfactants, solid diluents and liquid diluents.

This invention also relates to a method for controlling plant diseases caused by fungal plant pathogens comprising applying to the plant or portion thereof, or to the plant seed or seedling, a fungicidally effective amount of a mixture of the invention (e.g., as a composition described herein).

### DETAILS OF THE INVENTION

In the above recitations, the term “alkyl”, used either alone or in compound words such as “alkylthio” or “haloalkyl” includes straight-chain or branched alkyl, such as, methyl, ethyl, n-propyl or i-propyl. As referred to herein “alkylene” denotes alkanediyl with a straight-chain backbone. “C₃ alkylene” in the definition of substituent A means —CH₂CH₂CH₂—, one end of which is connected to substituent W and the other end of which is connected to the remainder of Formula I through the oxygen atom as depicted. “Alkylthio” includes methylthio and ethylthio. “Alkylsulfinyl” includes both enantiomers of an alkylsulfinyl group. Examples of “alkylsulfinyl” include CH₃S(O) and CH₃CH₂S(O). Examples of “alkylsulfonyl” include CH₃S(O)₂ and CH₃CH₂S(O)₂. The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The total number of carbon atoms in a substituent group is indicated by the “Cᵢ-Cⱼ” prefix where i and j are numbers from i to j. For example, C₁-C₃ alkyl designates methyl through propyl.

When a group contains a substituent which can be hydrogen, for example R³ or R⁵, then, when this substituent is taken as hydrogen, it is recognized that this is equivalent to said group being unsubstituted.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. Accordingly, the present invention comprises compounds selected from Formula I, N-oxides and agriculturally suitable salts thereof. The compounds of the invention may be present as a mixture of stereoisomers, individual stereoisomers, or as an optically active form.

One skilled in the art will recognize that tertiary amines can form N-oxides. Synthetic methods for the preparation of N-oxides of tertiary amines are very well known by one skilled in the art including the oxidation of tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydroxirane. These methods for the preparation of N-oxides have been extensively described and reviewed in the literature, see for example: T. L. Gilchrist in Comprehensive Organic Synthesis, vol. 7, pp 748-750, S. V. Ley (Ed.), Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky (Ed.), Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

Agriculturally suitable salts of the compounds in the mixtures of the present invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. Agriculturally suitable salts of the compounds in the mixtures of the present invention also include those formed with organic bases (pyridine, ammonia, or triethylamine) or inorganic bases (hydrides, hydroxides, or carbonates of sodium, potassium, lithium, calcium, magnesium or barium) when the compound contains an acidic group such as a carboxylic acid or phenol.

Embodiments of the present invention include:

Embodiment 1. A mixture comprising as component (a) a compound of Formula I, or an agriculturally suitable salt, wherein R¹ is methyl or ethyl, and R² is methyl, ethyl or cyclopropyl.

Embodiment 2. A mixture of Embodiment 1 wherein component (a) is selected from the group consisting of
N′-[5-trifluoromethyl-2-methyl-4-[3-(trimethylsilyl)propoxyl]phenyl]-N-ethyl-N-methylmethanimidamide; and
N′-[5-difluoromethyl-2-methyl-4-[3-(trimethylsilyl)propoxyl]phenyl]-N-ethyl-N-methylmethanimidamide.

Embodiment 3. A mixture of Embodiment 2 wherein component (a) is N′-[5-trifluoro-methyl-2-methyl-4-[3-(trimethylsilyl)propoxyl]phenyl]-N-ethyl-N-methylmethanimidamide.

Embodiment 4. A mixture of Embodiment 2 wherein component (a) is N-[5-difluoro-methyl-2-methyl-4-[3-(trimethylsilyl)propoxyl]phenyl]-N-ethyl-N-methylmethanimidamide.

Of note is a mixture comprising component (a) of any of Embodiments 1 through 4 and component (b) comprises at least one compound selected from the group consisting of (b2), (b4) and (b5).

Embodiment 5. A mixture wherein component (b) is a compound selected from (b1).

Embodiment 6. A mixture of Embodiment 5 wherein component (b) is mancozeb.

Embodiment 7. A mixture wherein component (b) is a compound selected from (b2).

Embodiment 8. A mixture of Embodiment 7 wherein component (b) is a compound selected from azoxystrobin and famoxadone.

Embodiment 9. A mixture of Embodiment 8 wherein component (b) is azoxystrobin.

Embodiment 10. A mixture of Embodiment 8 wherein component (b) is famoxadone.

Embodiment 11. A mixture wherein component (b) is the compound (b3) cymoxanil.

Embodiment 12. A mixture wherein component (b) is a compound selected from (b4).

Embodiment 13. A mixture of Embodiment 12 wherein component (b) is flusilazole.

Embodiment 14. A mixture wherein component (b) is a compound selected from (b5).

Embodiment 15. A mixture of Embodiment 14 wherein component (b) is fenpropimorph.

Embodiment 16. A mixture wherein component (b) is a compound selected from (b6).

Embodiment 17. A mixture wherein component (b) is a compound selected from (b7).

Embodiment 18. A mixture of Embodiment 17 wherein component (b) is proquinazid.

Embodiment 19. A mixture wherein component (b) is the compound (b8) chlorothalonil.

Embodiment 20. A mixture wherein component (b) is a compound selected from (b9).

Embodiment 21. A mixture of Embodiment 20 wherein component (b) is boscalid.

Embodiment 22. A mixture wherein component (b) is the compound (b10) quinoxyfen.

Embodiment 23. A mixture wherein component (b) is the compound (b11) metrafenone.

Embodiment 24. A mixture wherein component (b) is the compound (b12) cyflufenamid.

Embodiment 25. A mixture wherein component (b) is the compound (b13) cyprodinil.

Embodiment 26. A mixture wherein component (b) is a compound selected from (b14).

Embodiment 27. A mixture of Embodiment 26 wherein component (b) is selected from the group consisting of copper oxychloride, copper sulfate and copper hydroxide.

Embodiment 28. A mixture of Embodiment 26 wherein component (b) is copper hydroxide.

Embodiment 29. A mixture wherein component (b) is a compound selected from (b15).

Embodiment 30. A mixture wherein component (b) is the compound (b16) fosetyl-aluminum.

Embodiment 31. A mixture wherein component (b) is a compound selected from (b17).

Embodiment 32. A mixture wherein component (b) is the compound (b18) cyazofamid.

Embodiment 33. A mixture wherein component (b) is the compound (b19) fluazinam.

Embodiment 34. A mixture wherein component (b) is the compound (b20) iprovalicarb.

Embodiment 35. A mixture wherein component (b) is the compound (b21) propamocarb.

Embodiment 36. A mixture wherein component (b) is the compound (b22) validamycin.

Embodiment 37. A mixture wherein component (b) is a compound selected from (b23).

Embodiment 38. A mixture wherein component (b) is the compound (b24) zoxamide.

Embodiment 39. A mixture wherein component (b) is the compound (b25) dimethomorph.

Embodiment 40. A mixture wherein component (b) comprises at least one compound from each of two different groups selected from (b1), (b2), (b3), (b4), (b5), (b6), (b7), (b8), (b9), (b10), (b11), (b12), (b13), (b14), (b15), (b16), (b17), (b18), (b19), (b20), (b21), (b22), (b23), (b24) and (b25).

Also noteworthy as embodiments are fungicidal compositions of the present invention comprising a fungicidally effective amount of a mixture of Embodiments 1 to 40 and at least one additional component selected from the group consisting of surfactants, solid diluents and liquid diluents. Embodiments of the invention further include methods for controlling plant diseases caused by fungal plant pathogens comprising applying to the plant or portion thereof, or to the plant seed or seedling, a fungicidally effective amount of a mixture of Embodiments 1 to 40 (e.g., as a composition described herein).

The compounds of Formula I can be prepared by one or more of the methods and variations thereof as described in World Patent Application Publication WO 2003/093224.

Tables 1 to 7 list specific compounds of Formula I useful in the fungicidal mixtures, compositions and methods of the present invention. These compounds are to be construed as illustrative and not limiting of the disclosure in any way.

The following abbreviations are used in the Tables which follow: t means tertiary, s means secondary, n means normal, i means iso, and c means cyclo. “Compd. No.” means Compound Number.

TABLE 1

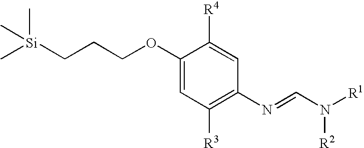

| Compd. | | | | |
|---|---|---|---|---|
| No. | R¹ | R² | R³ | R⁴ |
| | CH₃ | CH₃ | CH₃ | CH₃ |
| | CH₃ | C₂H₅ | CH₃ | CH₃ |
| | C₂H₅ | C₂H₅ | CH₃ | CH₃ |
| | CH₃ | i-C₃H₇ | CH₃ | CH₃ |
| | CH₃ | c-C₃H₇ | CH₃ | CH₃ |
| | CH₃ | CH₃ | CH₃ | OCH₃ |
| | CH₃ | C₂H₅ | CH₃ | OCH₃ |
| | C₂H₅ | C₂H₅ | CH₃ | OCH₃ |
| | CH₃ | i-C₃H₇ | CH₃ | OCH₃ |
| | CH₃ | c-C₃H₇ | CH₃ | OCH₃ |
| | CH₃ | CH₃ | CH₃ | OCHF₂ |
| | CH₃ | C₂H₅ | CH₃ | OCHF₂ |
| | CH₃ | C₂H₅ | CH₃ | OCHF₂ |
| | CH₃ | i-C₃H₇ | CH₃ | OCHF₂ |
| | CH₃ | c-C₃H₇ | CH₃ | OCHF₂ |
| | CH₃ | C₂H₅ | CH₃ | C₂H₅ |
| | CH₃ | C₂H₅ | CH₃ | CHFCF₃ |
| | CH₃ | C₂H₅ | CH₃ | CF₂CF₃ |
| | CH₃ | C₂H₅ | CH₃ | CHCl₂ |
| | CH₃ | C₂H₅ | CH₃ | CCl₃ |
| | CH₃ | CH₃ | H | CF₃ |
| | CH₃ | C₂H₅ | H | CF₃ |
| | C₂H₅ | C₂H₅ | H | CF₃ |
| | CH₃ | i-C₃H₇ | H | CF₃ |
| | CH₃ | c-C₃H₇ | H | CF₃ |
| | CH₃ | CH₃ | H | CHF₂ |
| | CH₃ | C₂H₅ | H | CHF₂ |
| | C₂H₅ | C₂H₅ | H | CHF₂ |
| | CH₃ | i-C₃H₇ | H | CHF₂ |
| | CH₃ | c-C₃H₇ | H | CHF₂ |
| | CH₃ | C₂H₅ | I | OCH₃ |
| | CH₃ | C₂H₅ | F | OCH₃ |
| | CH₃ | C₂H₅ | Cl | OCH₃ |
| | CH₃ | C₂H₅ | H | OCH₃ |
| | CH₃ | C₂H₅ | Br | OCH₃ |
| | CH₃ | CH₃ | CH₃ | CF₃ |
| 1 | CH₃ | C₂H₅ | CH₃ | CF₃ |
| | C₂H₅ | C₂H₅ | CH₃ | CF₃ |
| | CH₃ | i-C₃H₇ | CH₃ | CF₃ |
| | CH₃ | c-C₃H₇ | CH₃ | CF₃ |
| | CH₃ | CH₃ | CH₃ | CHF₂ |
| 2 | CH₃ | C₂H₅ | CH₃ | CHF₂ |
| | C₂H₅ | C₂H₅ | CH₃ | CHF₂ |
| | CH₃ | i-C₃H₇ | CH₃ | CHF₂ |
| | CH₃ | c-C₃H₇ | CH₃ | CHF₂ |
| | CH₃ | CH₃ | Cl | CF₃ |
| | CH₃ | C₂H₅ | Cl | CF₃ |
| | C₂H₅ | C₂H₅ | Cl | CF₃ |
| | CH₃ | i-C₃H₇ | Cl | CF₃ |
| | CH₃ | c-C₃H₇ | Cl | CF₃ |
| | CH₃ | CH₃ | Cl | CHF₂ |
| | CH₃ | C₂H₅ | Cl | CHF₂ |
| | C₂H₅ | C₂H₅ | Cl | CHF₂ |
| | CH₃ | i-C₃H₇ | Cl | CHF₂ |
| | CH₃ | c-C₃H₇ | Cl | CHF₂ |
| | CH₃ | CH₃ | Br | CF₃ |
| | CH₃ | C₂H₅ | Br | CF₃ |
| | C₂H₅ | C₂H₅ | Br | CF₃ |
| | CH₃ | i-C₃H₇ | Br | CF₃ |
| | CH₃ | c-C₃H₇ | Br | CF₃ |
| | CH₃ | CH₃ | Br | CHF₂ |
| | CH₃ | C₂H₅ | Br | CHF₂ |
| | C₂H₅ | C₂H₅ | Br | CHF₂ |
| | CH₃ | i-C₃H₇ | Br | CHF₂ |
| | CH₃ | c-C₃H₇ | Br | CHF₂ |
| | CH₃ | C₂H₅ | I | CF₃ |
| | CH₃ | C₂H₅ | F | CF₃ |
| | CH₃ | C₂H₅ | I | CHF₂ |
| | CH₃ | C₂H₅ | F | CHF₂ |
| | CH₃ | C₂H₅ | Cl | OCHF₂ |
| | CH₃ | C₂H₅ | Br | OCHF₂ |

TABLE 2

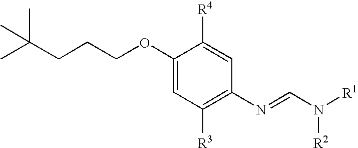

| R¹ | R² | R³ | R⁴ |
|---|---|---|---|
| CH₃ | CH₃ | CH₃ | CF₃ |
| CH₃ | C₂H₅ | CH₃ | CF₃ |
| C₂H₅ | C₂H₅ | CH₃ | CF₃ |
| CH₃ | i-C₃H₇ | CH₃ | CF₃ |
| CH₃ | c-C₃H₇ | CH₃ | CF₃ |
| CH₃ | CH₃ | CH₃ | CHF₂ |
| CH₃ | C₂H₅ | CH₃ | CHF₂ |
| C₂H₅ | C₂H₅ | CH₃ | CHF₂ |
| CH₃ | i-C₃H₇ | CH₃ | CHF₂ |
| CH₃ | c-C₃H₇ | CH₃ | CHF₂ |
| CH₃ | CH₃ | H | CF₃ |
| CH₃ | C₂H₅ | H | CF₃ |
| C₂H₅ | C₂H₅ | H | CF₃ |
| CH₃ | i-C₃H₇ | H | CF₃ |
| CH₃ | c-C₃H₇ | H | CF₃ |
| CH₃ | CH₃ | H | CHF₂ |
| CH₃ | C₂H₅ | H | CHF₂ |
| C₂H₅ | C₂H₅ | H | CHF₂ |
| CH₃ | i-C₃H₇ | H | CHF₂ |
| CH₃ | c-C₃H₇ | H | CHF₂ |
| CH₃ | C₂H₅ | I | OCH₃ |
| CH₃ | C₂H₅ | F | OCH₃ |
| CH₃ | C₂H₅ | Cl | OCH₃ |
| CH₃ | C₂H₅ | H | OCH₃ |
| CH₃ | C₂H₅ | Br | OCH₃ |
| CH₃ | CH₃ | Cl | CF₃ |
| CH₃ | C₂H₅ | Cl | CF₃ |
| C₂H₅ | C₂H₅ | Cl | CF₃ |
| CH₃ | i-C₃H₇ | Cl | CF₃ |
| CH₃ | c-C₃H₇ | Cl | CF₃ |
| CH₃ | CH₃ | Cl | CHF₂ |
| CH₃ | C₂H₅ | Cl | CHF₂ |
| C₂H₅ | C₂H₅ | Cl | CHF₂ |
| CH₃ | i-C₃H₇ | Cl | CHF₂ |
| CH₃ | c-C₃H₇ | Cl | CHF₂ |
| CH₃ | CH₃ | Br | CF₃ |
| CH₃ | C₂H₅ | Br | CF₃ |
| C₂H₅ | C₂H₅ | Br | CF₃ |
| CH₃ | i-C₃H₇ | Br | CF₃ |
| CH₃ | c-C₃H₇ | Br | CF₃ |
| CH₃ | CH₃ | Br | CHF₂ |
| CH₃ | C₂H₅ | Br | CHF₂ |
| C₂H₅ | C₂H₅ | Br | CHF₂ |
| CH₃ | i-C₃H₇ | Br | CHF₂ |
| CH₃ | c-C₃H₇ | Br | CHF₂ |
| CH₃ | C₂H₅ | I | CF₃ |
| CH₃ | C₂H₅ | F | CF₃ |
| CH₃ | C₂H₅ | I | CHF₂ |
| CH₃ | C₂H₅ | F | CHF₂ |
| CH₃ | C₂H₅ | Cl | OCHF₂ |
| CH₃ | C₂H₅ | Br | OCHF₂ |

TABLE 3

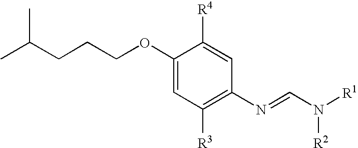

| R¹ | R² | R³ | R⁴ |
|---|---|---|---|
| CH₃ | CH₃ | CH₃ | CF₃ |
| CH₃ | C₂H₅ | CH₃ | CF₃ |
| C₂H₅ | C₂H₅ | CH₃ | CF₃ |
| CH₃ | i-C₃H₇ | CH₃ | CF₃ |
| CH₃ | c-C₃H₇ | CH₃ | CF₃ |
| CH₃ | CH₃ | CH₃ | CHF₂ |
| CH₃ | C₂H₅ | CH₃ | CHF₂ |
| C₂H₅ | C₂H₅ | CH₃ | CHF₂ |
| CH₃ | i-C₃H₇ | CH₃ | CHF₂ |
| CH₃ | c-C₃H₇ | CH₃ | CHF₂ |
| CH₃ | CH₃ | H | CF₃ |
| CH₃ | C₂H₅ | H | CF₃ |
| C₂H₅ | C₂H₅ | H | CF₃ |
| CH₃ | i-C₃H₇ | H | CF₃ |
| CH₃ | c-C₃H₇ | H | CF₃ |
| CH₃ | CH₃ | H | CHF₂ |
| CH₃ | C₂H₅ | H | CHF₂ |
| C₂H₅ | C₂H₅ | H | CHF₂ |
| CH₃ | i-C₃H₇ | H | CHF₂ |
| CH₃ | c-C₃H₇ | H | CHF₂ |
| CH₃ | C₂H₅ | I | OCH₃ |
| CH₃ | C₂H₅ | F | OCH₃ |
| CH₃ | C₂H₅ | Cl | OCH₃ |
| CH₃ | C₂H₅ | H | OCH₃ |
| CH₃ | C₂H₅ | Br | OCH₃ |
| CH₃ | CH₃ | Cl | CF₃ |
| CH₃ | C₂H₅ | Cl | CF₃ |
| C₂H₅ | C₂H₅ | Cl | CF₃ |
| CH₃ | i-C₃H₇ | Cl | CF₃ |
| CH₃ | c-C₃H₇ | Cl | CF₃ |
| CH₃ | CH₃ | Cl | CHF₂ |
| CH₃ | C₂H₅ | Cl | CHF₂ |
| C₂H₅ | C₂H₅ | Cl | CHF₂ |
| CH₃ | i-C₃H₇ | Cl | CHF₂ |
| CH₃ | c-C₃H₇ | Cl | CHF₂ |
| CH₃ | CH₃ | Br | CF₃ |
| CH₃ | C₂H₅ | Br | CF₃ |
| C₂H₅ | C₂H₅ | Br | CF₃ |
| CH₃ | i-C₃H₇ | Br | CF₃ |
| CH₃ | c-C₃H₇ | Br | CF₃ |
| CH₃ | CH₃ | Br | CHF₂ |
| CH₃ | C₂H₅ | Br | CHF₂ |
| C₂H₅ | C₂H₅ | Br | CHF₂ |
| CH₃ | i-C₃H₇ | Br | CHF₂ |
| CH₃ | c-C₃H₇ | Br | CHF₂ |
| CH₃ | C₂H₅ | I | CF₃ |
| CH₃ | C₂H₅ | F | CF₃ |
| CH₃ | C₂H₅ | I | CHF₂ |
| CH₃ | C₂H₅ | F | CHF₂ |
| CH₃ | C₂H₅ | Cl | OCHF₂ |
| CH₃ | C₂H₅ | Br | OCHF₂ |

TABLE 4

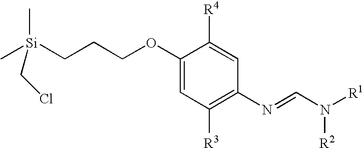

| R¹ | R² | R³ | R⁴ |
|---|---|---|---|
| CH₃ | CH₃ | CH₃ | CF₃ |
| CH₃ | C₂H₅ | CH₃ | CF₃ |
| C₂H₅ | C₂H₅ | CH₃ | CF₃ |
| CH₃ | i-C₃H₇ | CH₃ | CF₃ |
| CH₃ | c-C₃H₇ | CH₃ | CF₃ |
| CH₃ | CH₃ | CH₃ | CHF₂ |
| CH₃ | C₂H₅ | CH₃ | CHF₂ |
| C₂H₅ | C₂H₅ | CH₃ | CHF₂ |
| CH₃ | i-C₃H₇ | CH₃ | CHF₂ |
| CH₃ | c-C₃H₇ | CH₃ | CHF₂ |
| CH₃ | CH₃ | H | CF₃ |
| CH₃ | C₂H₅ | H | CF₃ |
| C₂H₅ | C₂H₅ | H | CF₃ |
| CH₃ | i-C₃H₇ | H | CF₃ |
| CH₃ | c-C₃H₇ | H | CF₃ |
| CH₃ | CH₃ | H | CHF₂ |
| CH₃ | C₂H₅ | H | CHF₂ |
| C₂H₅ | C₂H₅ | H | CHF₂ |
| CH₃ | i-C₃H₇ | H | CHF₂ |
| CH₃ | c-C₃H₇ | H | CHF₂ |
| CH₃ | C₂H₅ | I | OCH₃ |
| CH₃ | C₂H₅ | F | OCH₃ |
| CH₃ | C₂H₅ | Cl | OCH₃ |
| CH₃ | C₂H₅ | H | OCH₃ |
| CH₃ | C₂H₅ | Br | OCH₃ |
| CH₃ | CH₃ | Cl | CF₃ |
| CH₃ | C₂H₅ | Cl | CF₃ |
| C₂H₅ | C₂H₅ | Cl | CF₃ |
| CH₃ | i-C₃H₇ | Cl | CF₃ |
| CH₃ | c-C₃H₇ | Cl | CF₃ |
| CH₃ | CH₃ | Cl | CHF₂ |
| CH₃ | C₂H₅ | Cl | CHF₂ |
| C₂H₅ | C₂H₅ | Cl | CHF₂ |
| CH₃ | i-C₃H₇ | Cl | CHF₂ |
| CH₃ | c-C₃H₇ | Cl | CHF₂ |
| CH₃ | CH₃ | Br | CF₃ |
| CH₃ | C₂H₅ | Br | CF₃ |
| C₂H₅ | C₂H₅ | Br | CF₃ |
| CH₃ | i-C₃H₇ | Br | CF₃ |
| CH₃ | c-C₃H₇ | Br | CF₃ |
| CH₃ | CH₃ | Br | CHF₂ |
| CH₃ | C₂H₅ | Br | CHF₂ |
| C₂H₅ | C₂H₅ | Br | CHF₂ |
| CH₃ | i-C₃H₇ | Br | CHF₂ |
| CH₃ | c-C₃H₇ | Br | CHF₂ |
| CH₃ | C₂H₅ | I | CF₃ |
| CH₃ | C₂H₅ | F | CF₃ |
| CH₃ | C₂H₅ | I | CHF₂ |
| CH₃ | C₂H₅ | F | CHF₂ |
| CH₃ | C₂H₅ | Cl | OCHF₂ |
| CH₃ | C₂H₅ | Br | OCHF₂ |

TABLE 5

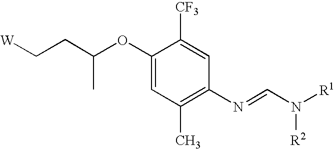

| W | R¹ | R² |
|---|---|---|
| (CH₃)₃Si | CH₃ | CH₃ |
| (CH₃)₃Si | CH₃ | C₂H₅ |
| (CH₃)₃Si | C₂H₅ | C₂H₅ |
| (CH₃)₃Si | CH₃ | i-C₃H₇ |
| (CH₃)₃Si | CH₃ | c-C₃H₇ |
| ClCH₂(CH₃)₂Si | CH₃ | CH₃ |
| ClCH₂(CH₃)₂Si | CH₃ | C₂H₅ |
| ClCH₂(CH₃)₂Si | C₂H₅ | C₂H₅ |
| ClCH₂(CH₃)₂Si | CH₃ | i-C₃H₇ |
| ClCH₂(CH₃)₂Si | CH₃ | c-C₃H₇ |
| (CH₃)₃C | CH₃ | CH₃ |
| (CH₃)₃C | CH₃ | C₂H₅ |
| (CH₃)₃C | C₂H₅ | C₂H₅ |
| (CH₃)₃C | CH₃ | i-C₃H₇ |
| (CH₃)₃C | CH₃ | c-C₃H₇ |
| (CH₃)₂CH | CH₃ | CH₃ |
| (CH₃)₂CH | CH₃ | C₂H₅ |
| (CH₃)₂CH | C₂H₅ | C₂H₅ |
| (CH₃)₂CH | CH₃ | i-C₃H₇ |
| (CH₃)₂CH | CH₃ | c-C₃H₇ |

TABLE 6

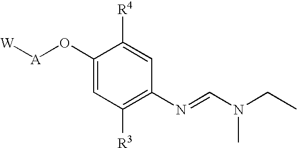

| W | A | R³ | R⁴ |
|---|---|---|---|
| BrCH₂(CH₃)₂Si | CH₂CH₂CH₂ | CH₃ | CF₃ |
| FCH₂(CH₃)₂Si | CH₂CH₂CH₂ | CH₃ | CF₃ |
| ICH₂(CH₃)₂Si | CH₂CH₂CH₂ | CH₃ | CF₃ |
| BrCH₂(CH₃)₂Si | CH₂CH₂CH₂ | CH₃ | CHF₂ |
| FCH₂(CH₃)₂Si | CH₂CH₂CH₂ | CH₃ | CHF₂ |
| ICH₂(CH₃)₂Si | CH₂CH₂CH₂ | CH₃ | CHF₂ |
| (CH₃)₂CH | CH₂CH₂CH₂ | CH₃ | Cl |
| (CH₃)₃C | CH₂CH₂CH₂ | CH₃ | Cl |
| (CH₃)₃Si | CH₂CH₂CH₂ | CH₃ | Cl |
| ClCH₂(CH₃)₂Si | CH₂CH₂CH₂ | CH₃ | Cl |
| ICH₂(CH₃)₂Si | CH₂CH₂CH₂ | CH₃ | Cl |
| BrCH₂(CH₃)₂Si | CH₂CH₂CH₂ | CH₃ | Cl |
| FCH₂(CH₃)₂Si | CH₂CH₂CH₂ | CH₃ | Cl |
| ClCH₂(CH₃)₂Si | CH₂CH₂CH₂ | CH₃ | Cl |
| (CH₃)₂CH | CH₂CH₂CH₂ | CH₃ | Br |
| (CH₃)₃C | CH₂CH₂CH₂ | CH₃ | Br |
| (CH₃)₃Si | CH₂CH₂CH₂ | CH₃ | Br |
| ClCH₂(CH₃)₂Si | CH₂CH₂CH₂ | CH₃ | Br |
| ICH₂(CH₃)₂Si | CH₂CH₂CH₂ | CH₃ | Br |
| BrCH₂(CH₃)₂Si | CH₂CH₂CH₂ | CH₃ | Br |
| FCH₂(CH₃)₂Si | CH₂CH₂CH₂ | CH₃ | Br |
| ClCH₂(CH₃)₂Si | CH₂CH₂CH₂ | CH₃ | Br |
| (CH₃)₂CH | CH₂CH₂CH₂ | CH₃ | F |
| (CH₃)₃C | CH₂CH₂CH₂ | CH₃ | F |
| (CH₃)₃Si | CH₂CH₂CH₂ | CH₃ | F |
| ClCH₂(CH₃)₂Si | CH₂CH₂CH₂ | CH₃ | F |
| (CH₃)₂CH | CH₂CH₂CH₂ | CH₃ | I |
| (CH₃)₃C | CH₂CH₂CH₂ | CH₃ | I |
| (CH₃)₃Si | CH₂CH₂CH₂ | CH₃ | I |
| ClCH₂(CH₃)₂Si | CH₂CH₂CH₂ | CH₃ | I |
| C₂H₅(CH₃)₂Si | CH₂CH₂CH₂ | CH₃ | CF₃ |
| CH₃(C₂H₅)₂Si | CH₂CH₂CH₂ | CH₃ | CF₃ |
| CH₃CH₂CH₂(CH₃)₂Si | CH₂CH₂CH₂ | CH₃ | CF₃ |
| C₂H₅(CH₃)₂Si | CH₂CH₂CH₂ | CH₃ | CHF₂ |
| CH₃(C₂H₅)₂Si | CH₂CH₂CH₂ | CH₃ | CHF₂ |
| CH₃CH₂CH₂(CH₃)₂Si | CH₂CH₂CH₂ | CH₃ | CHF₂ |
| C₂H₅(CH₃)₂Si | CH₂CH₂CH₂ | CH₃ | Cl |
| CH₃(C₂H₅)₂Si | CH₂CH₂CH₂ | CH₃ | Cl |
| CH₃CH₂CH₂(CH₃)₂Si | CH₂CH₂CH₂ | CH₃ | Cl |
| ClCF₂(CH₃)₂Si | CH₂CH₂CH₂ | CH₃ | Cl |
| CHF₂(CH₃)₂C | CH₂CH₂CH₂ | CH₃ | Cl |
| ClCF₂(CH₃)₂Si | CH₂CH₂CH₂ | CH₃ | CF₃ |
| CHF₂(CH₃)₂C | CH₂CH₂CH₂ | CH₃ | CF₃ |
| ClCF₂(CH₃)₂Si | CH₂CH₂CH₂ | CH₃ | CHF₂ |
| CHF₂(CH₃)₂C | CH₂CH₂CH₂ | CH₃ | CHF₂ |
| (CH₃)₃Si | CH₂CH(CH₃)CH₂ | CH₃ | CF₃ |
| (CH₃)₃Si | CH₂CH(CH₃)CH₂ | CH₃ | CHF₂ |
| (CH₃)₃Si | CH(CH₃)CH₂CH₂ | CH₃ | CF₃ |
| (CH₃)₃Si | CH(CH₃)CH₂CH₂ | CH₃ | CHF₂ |
| C₂H₅(CH₃)₂C | CH₂CH₂CH₂ | CH₃ | CF₃ |
| C₂H₅(CH₃)₂C | CH₂CH₂CH₂ | CH₃ | CHF₂ |
| C₂H₅(CH₃)₂C | CH₂CH₂CH₂ | CH₃ | Cl |
| C₂H₅(CH₃)₂C | CH₂CH₂CH₂ | CH₃ | Br |
| (CH₃)₂CH | CH₂CH₂CH₂ | C₂H₅ | CF₃ |
| (CH₃)₃C | CH₂CH₂CH₂ | C₂H₅ | CF₃ |
| (CH₃)₃Si | CH₂CH₂CH₂ | C₂H₅ | CF₃ |
| ClCH₂(CH₃)₂Si | CH₂CH₂CH₂ | C₂H₅ | CF₃ |
| (CH₃)₃Si | CH₂CH₂CH₂ | C₂H₅ | CHF₂ |
| ClCH₂(CH₃)₂Si | CH₂CH₂CH₂ | C₂H₅ | CHF₂ |
| (CH₃)₃Si | CH₂CH₂CH₂ | C₂H₅ | Cl |

In Table 6 the left end of the radical shown for A connects to W and the right end of the radical shown for W connects to the oxygen atom of the remaining part of the molecular structure.

TABLE 7

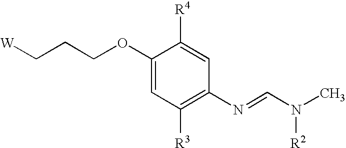

| W | R² | R³ | R⁴ |
|---|---|---|---|
| (CH₃)₃Si | C₂H₅ | CH₃ | SCH₃ |
| (CH₃)₃C | C₂H₅ | CH₃ | SCH₃ |
| (CH₃)₂CH | C₂H₅ | CH₃ | SCH₃ |
| (CH₃)₃Si | CH₃ | C₂H₅ | S(O)CH₃ |
| (CH₃)₃C | CH₃ | C₂H₅ | S(O)CH₃ |
| (CH₃)₂CH | C₂H₅ | CH₃ | S(O)CH₃ |
| (CH₃)₃Si | C₂H₅ | CH₃ | S(O)₂CH₃ |
| (CH₃)₃C | C₂H₅ | CH₃ | S(O)₂CH₃ |
| (CH₃)₂CH | C₂H₅ | CH₃ | S(O)₂CH₃ |
| (CH₃)₃Si | i-C₃H₇ | CH₃ | SCH₃ |
| (CH₃)₃C | i-C₃H₇ | CH₃ | SCH₃ |
| (CH₃)₂CH | i-C₃H₇ | CH₃ | SCH₃ |
| (CH₃)₃Si | i-C₃H₇ | CH₃ | S(O)CH₃ |
| (CH₃)₃C | i-C₃H₇ | CH₃ | S(O)CH₃ |
| (CH₃)₂CH | i-C₃H₇ | CH₃ | S(O)CH₃ |
| (CH₃)₃Si | i-C₃H₇ | CH₃ | S(O)₂CH₃ |
| (CH₃)₃C | i-C₃H₇ | CH₃ | S(O)₂CH₃ |
| (CH₃)₂CH | i-C₃H₇ | CH₃ | S(O)₂CH₃ |

The fungicidal compounds of groups (b1), (b2), (b3), (b4), (b5), (b6), (b7), (b8), (b9), (b10), (b11), (b12), (b13), (b14), (b15), (b16), (b17), (b18), (b19), (b20), (b21), (b22), (b23), (b24) and (b25) have been described in published patents and scientific journal papers. Most of these compounds are commercially available as active ingredients in fungicidal products. These compounds are described in compendia such as The Pesticide Manual, 13th edition, C. D. S. Thomlin (Ed.), British Crop Protection Council, Surrey, UK, 2003. Certain of these groups are further described below.

bc₁ Complex Fungicides (Group (b2))

Strobilurin fungicides such as azoxystrobin, kresoxim-methyl, discostrobin, dimoxystrobin, fluoxastrobin, metominostrobin/fenominostrobin (SSF-126), picoxystrobin, pyraclostrobin and trifloxystrobin are known to have a fungicidal mode of action which inhibits the bc₁ complex in the mitochondrial respiration chain (Angew. Chem. Int. Ed., 1999, 38, 1328-1349). Methyl (E)-2-[[6-(2-cyanophenoxy)-4-pyrimidinyl]oxy]-α-(methoxyimino)benzeneacetate (also known as azoxystrobin) is described as a bc₁ complex inhibitor in Biochemical Society Transactions 1993, 22, 68S. Methyl (E)-α-(methoxyimino)-2-[(2-methylphenoxy)methyl]benzeneacetate (also known as kresoxim-methyl) is described as a bc₁ complex inhibitor in Biochemical Society Transactions 1993, 22, 64S. (E)-2-[(2,5-Dimethylphenoxy)methyl]-α-(methoxyimino)-N-methylbenzeneacetamide is described as a bc₁ complex inhibitor in Biochemistry and Cell Biology 1995, 85(3), 306-311. Other compounds that inhibit the bc₁ complex in the mitochondrial respiration chain include famoxadone and fenamidone.

The bc₁ complex is sometimes referred to by other names in the biochemical literature, including complex III of the electron transfer chain, and ubihydroquinone:cytochrome c oxidoreductase. It is uniquely identified by the Enzyme Commission number EC1.10.2.2. The bc₁ complex is described in, for example, J. Biol. Chem. 1989, 264, 14543-48; Methods Enzymol. 1986, 126, 253-71; and references cited therein.

Sterol Biosynthesis Inhibitor Fungicides (Groups (b4) and (b5))

The class of sterol biosynthesis inhibitors includes DMI and non-DMI fungicides, that control fungi by inhibiting enzymes in the sterol biosynthesis pathway. DMI fungicides (group (b4)) have a common site of action within the fungal sterol biosynthesis pathway; that is, an inhibition of demethylation at position 14 of lanosterol or 24-methylene dihydrolanosterol, which are precursors to sterols in fungi. Compounds acting at this site are often referred to as demethylase inhibitors, DMI fungicides, or DMIs. The demethylase enzyme is sometimes referred to by other names in the biochemical literature, including cytochrome P-450 (14DM). The demethylase enzyme is described in, for example, J. Biol. Chem. 1992, 267, 13175-79 and references cited therein. DMI fungicides fall into several classes: azoles (including triazoles and imidazoles), pyrimidines, piperazines and pyridines. The triazoles include azaconazole, bromuconazole, cyproconazole, difenoconazole, diniconazole, epoxiconazole, fenbuconazole, fluquinconazole, flusilazole, flutriafol, hexaconazole, ipconazole, metconazole, penconazole, propiconazole, prothioconazole, simeconazole, tebuconazole, tetraconazole, triadimefon, triadimenol, triticonazole and uniconazole. The imidazoles include clotrimazole, econazole, imazalil, isoconazole, miconazole and prochloraz. The pyrimidines include fenarimol, nuarimol and triarimol. The piperazines include triforine. The pyridines include buthiobate and pyrifenox. Biochemical investigations have shown that all of the above mentioned fungicides are DMI fungicides as described by K. H. Kuck, et al. in Modern Selective Fungicides—Properties, Applications and Mechanisms of Action, H. Lyr (Ed.), Gustav Fischer Verlag: New York, 1995, 205-258.

The DMI fungicides have been grouped together to distinguish them from other sterol biosynthesis inhibitors, such as, the morpholine and piperidine fungicides (group (b5)). The morpholines and piperidines are also sterol biosynthesis inhibitors but have been shown to inhibit later steps in the sterol biosynthesis pathway. The morpholines include aldimorph, dodemorph, fenpropimorph, tridemorph and trimorphamide. The piperidines include fenpropidin. Biochemical investigations have shown that all of the above mentioned morpholine and piperidine fungicides are sterol biosynthesis inhibitor fungicides as described by K. H. Kuck, et al. in Modern Selective Fungicides—Properties, Applications and Mechanisms of Action, H. Lyr (Ed.), Gustav Fischer Verlag: New York, 1995, 185-204.

Pyrimidinone Fungicides (Group (b7))

Pyrimidinone fungicides include compounds of Formula II 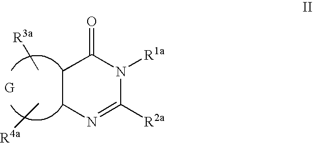
wherein

G forms a fused phenyl, thiophene or pyridine ring;

R^{1a} is C₁-C₆ alkyl;

R^{2a} is C₁-C₆ alkyl or C₁-C₆ alkoxy;

R^{3a} is halogen; and

R^{4a} is hydrogen or halogen.

Pyrimidinone fungicides are described in World Patent Application Publication WO 94/26722, U.S. Pat. No. 6,066,638, U.S. Pat. No. 6,245,770, U.S. Pat. No. 6,262,058 and U.S. Pat. No. 6,277,858.

Of note are pyrimidinone fungicides selected from the group:
6-bromo-3-propyl-2-propyloxy-4(3H)-quinazolinone,
6,8-diiodo-3-propyl-2-propyloxy-4(3H)-quinazolinone,
6-iodo-3-propyl-2-propyloxy-4(3H)-quinazolinone (proquinazid),
6-chloro-2-propoxy-3-propylthieno[2,3-d]pyrimidin-4(3H)-one,
6-bromo-2-propoxy-3-propylthieno[2,3-d]pyrimidin-4(3H)-one,
7-bromo-2-propoxy-3-propylthieno[3,2-d]pyrimidin-4(3H)-one,
6-bromo-2-propoxy-3-propylpyrido[2,3-d]pyrimidin-4(3H)-one,
6,7-dibromo-2-propoxy-3-propylthieno[3,2-d]pyrimidin-4(3H)-one, and
3-(cyclopropylmethyl)-6-iodo-2-(propylthio)pyrido[2,3-d]pyrimidin-4(3H)-one.
   Other Fungicide Groups

Alkylenebis(dithiocarbamate)s (b1) include compounds such as mancozeb, maneb, propineb and zineb.

Phenylamides (b6) include compounds such as metalaxyl, benalaxyl, furalaxyl and oxadixyl.

Copper compounds (b7) include compounds such as copper oxychloride, copper sulfate and copper hydroxide, including compositions such as Bordeaux mixture (tribasic copper sulfate).

Carboxamides (b9) include compounds such as boscalid, carboxin, fenfuram, flutolanil, furametpyr, mepronil, oxycarboxin and thifluzamide are known to inhibit mitochondrial function by disrupting complex II (succinate dehydrogenase) in the respiratory electron transport chain.

Phthalimides (b15) include compounds such as folpet and captan.

Benzimidazole fungicides (b17) include benomyl and carbendazim.

Dichlorophenyl dicarboximide fungicides (b23) include chlozolinate, dichlozoline, iprodione, isovaledione, myclozolin, procymidone and vinclozolin.

Other fungicides as well as other crop protection agents such as insecticides and miticides can be included in the mixtures and compositions of this invention as additional components in combination with component (a) and component (b). Other fungicides include acibenzolar, benthiavalicarb, blasticidin-S, carpropamid, captafol, captan, chloroneb, diclocymet (S-2900), diclomezine, dicloran, dodine, edifenphos, ethaboxam, fencaramid (SZX0722), fenhexamid, fenpiclonil, fenoxanil, fentin acetate, fentin hydroxide, ferbam, ferimzone, fludioxonil, flumetover (RPA 403397), folpet, guazatine, iprobenfos, isoprothiolane, kasugamycin, mefenoxam, metiram-zinc, myclobutanil, neo-asozin (ferric methanearsonate), oxadixyl, pencycuron, probenazole, prochloraz, propineb, pyrazophos, pyrifenox, pyrimethanil, pyroquilon, silthiofam, spiroxamine, sulfur, thiabendazole, thiophanate-methyl, thiram, tiadinil, triadimefon and tricyclazole.

Descriptions of the commercially available compounds listed above may be found in The Pesticide Manual, Thirteenth Edition, C. D. S. Tomlin (Ed.), British Crop Protection Council, 2003.

Of note are combinations of compounds of Formula I with fungicides of a different biochemical mode of action (e.g., mitochondrial respiration inhibition, inhibition of protein synthesis by interference of the synthesis of ribosomal RNA or inhibition of beta-tubulin synthesis) that can be particularly advantageous for resistance management. Examples include combinations of compounds of Formula I (Compound 1 identified in Table 1) with strobilurins such as azoxystrobin, dimoxystrobin, kresoxim-methyl, metominostrobin, picoxystrobin, pyraclostrobin, trifloxystrobin, and fluoxastrobin; DMIs such as cyproconazole, epoxiconazole, fluquinconazole, flusilazole, hexaconazole, metconazole, propiconazole, prothioconazole, tebuconazole; morpholines and piperidines such as fenpropimorph, tridemorph, fenpropidin; mitochondrial respiration inhibitors such as famoxadone and fenamidone; pyrimidinone fungicides such as proquinazid; boscalid; chlorothalonil; carbendazim; benomyl, cymoxanil; folpet; mancozeb and maneb; quinoxyfen; metrafenone; cyflufenamid; and cyprodinil. These combinations can be particularly advantageous for resistance management, especially where the fungicides of the combination control the same or similar diseases.

Of note are combinations of compounds of Formula I with fungicides that provide an expanded spectrum of disease control or enhanced efficacy, including enhanced residual, curative, or preventive control. Examples include combinations of compounds of Formula I (Compound 1 identified in Table 1) with strobilurins such as azoxystrobin, dimoxystrobin, kresoxim-methyl, metominostrobin, picoxystrobin, pyraclostrobin, trifloxystrobin, and fluoxastrobin; DMI's such as bromuconazole, cyproconazole, epoxiconazole, fluquinconazole, flusilazole, hexaconazole, metconazole, propiconazole, prothioconazole, tebuconazole; morpholines and piperidines such as fenpropimorph, tridemorph, fenpropidin; mitochondrial respiration inhibitors such as famoxadone and fenamidone; boscalid; chlorothalonil; carbendazim; benomyl, cymoxanil; dimethomorph; folpet; fosetyl-aluminum; phenylamide compounds such as metalaxyl, mefenoxam, and oxadixyl; mancozeb and maneb; quinoxyfen; metrafenone; cyflufenamid; cyprodinil; and copper compounds.

Of note are combinations of compounds of Formula I with fungicides for controlling cereal diseases (e.g., Erisyphe graminis, Septoria nodorum, Septoria tritici, Puccinia recondita) including strobilurins such as azoxystrobin, dimoxystrobin, kresoxim-methyl, metominostrobin, picoxystrobin, pyraclostrobin, trifloxystrobin, and fluoxastrobin; DMI's such as bromuconazole, cyproconazole, epoxiconazole, fluquinconazole, flusilazole, hexaconazole, metconazole, propiconazole, prothioconazole, tebuconazole; morpholines and piperidines such as fenpropimorph, tridemorph, fenpropidin; pyrimidinone fungicides such as proquinazid; boscalid; chlorothalonil; carbendazim; quinoxyfen; metrafenone; cyflufenamid; cyprodinil; and prochloraz.

Of note are combinations of compounds of Formula I with fungicides for controlling diseases of fruits and vegetables (Alternaria solani, Botrytis cinerea, Rhizoctonia solani, Uncinula necatur) including alkylenebis(dithiocarbamate)s such as mancozeb, maneb, propineb and zineb; phthalimides such as folpet; copper salts such as copper sulfate and copper hydroxide; strobilurins such as dimoxystrobin, kresoxim-methyl, metominostrobin, picoxystrobin, pyraclostrobin, trifloxystrobin, and fluoxastrobin; mitochondrial respiration inhibitors such as famoxadone and fenamidone; phenylamides such as metalaxyl and mefenoxam; phosphonates such as fosetyl-A1; pyrimidinone fungicides such as 6-iodo-3-propyl-2-propyloxy-4(3H)-quinazolinone and 6-chloro-2-propoxy-3-propylthieno[2,3-d]pyrimidin-4(3H)-one; carbamates such as propamocarb; phenylpyridylamines such as fluazinam; and other fungicides such as chlorothalonil, cyazofamid, cymoxanil, boscalid, cyprodinil, dimethomorph, zoxamid and iprovalicarb.

The weight ratios of component (b) to component (a) in the mixtures and compositions of the present invention are typically from 100:1 to 1:100, preferably from 25:1 to 1:25, and more preferably from 10:1 to 1:10. Of note are mixtures and compositions wherein the weight ratio of component (b) to component (a) is from 5:1 to 1:5. Of note are compositions wherein component (b) is a compound selected from (b2) and the weight ratio of component (b) to component (a) is from 1:1 to 1:100. Also of note are compositions wherein component (b) is a compound selected from (b4) and the weight ratio of component (b) to component (a) is from 20:1 to 1:20. Also of note are compositions wherein component (b) is a compound selected from (b5) and the weight ratio of component (b) to component (a) is from 5:1 to 1:5.

Of note are compositions wherein component (b) comprises at least one compound from each of two different groups selected from (b1), (b2), (b3), (b4), (b5), (b6), (b7), (b8), (b9), (b10), (b11), (b12), (b13), (b14), (b15), (b16), (b17), (b18), (b19), (b20), (b21), (b22), (b23), (b24) and (b25).

Of note are compositions wherein component (b) comprises at least one compound selected from (b2), for example azoxystrobin, and at least one compound selected from a second component (b) group, for example, from (b3), (b4), (b5), (b6), (b7), (b15) and (b16). Of particular note are such compositions wherein the overall weight ratio of component (b) to component (a) is from 100:1 to 1:100 and the weight ratio of component (b2) to component (a) is from 25:1 to 1:25. Included are compositions wherein the weight ratio of component (b2) to component (a) is from 1:1 to 1:100. Examples of these compositions include compositions comprising mixtures of component (a) (preferably a compound from Tables 1-7) with azoxystrobin (b2) and a compound selected from the group consisting of epoxiconazole, flusilazole, fenpropimorph, quinoxyfen, cymoxanil, metalaxyl, benalaxyl, oxadixyl, proquinazid, 6-chloro-2-propoxy-3-propylthieno[2,3-d]pyrimidin-4(3H)-one, folpet, captan and fosetyl-aluminum.

Of note are compositions wherein component (b) comprises at least one compound selected from (b4), for example flusilazole, and at least one compound selected from another component (b) group, for example, from (b2), (b3), (b5), (b6), (b7), (b15) and (b16). Of particular note are such compositions wherein the overall weight ratio of component (b) to component (a) is from 30:1 to 1:30 and the weight ratio of component (b4) to component (a) is from 20:1 to 1:20. Included are compositions wherein the weight ratio of component (b4) to component (a) is from 5:1 to 1:5. Examples of these compositions include compositions comprising mixtures of component (a) (preferably a compound from Tables 1-7) with flusilazole (b4) and a compound selected from the group consisting of azoxystrobin, fenpropimorph, quinoxyfen, famoxadone, fenamidone, cymoxanil, metalaxyl, benalaxyl, oxadixyl, proquinazid, 6-chloro-2-propoxy-3-propylthieno[2,3-d]pyrimidin-4(3H)-one, folpet, captan and fosetyl-aluminum.

Of note are compositions wherein component (b) comprises at least one compound selected from (b5), for example fenpropimorph, and at least one compound selected from another component (b) group, for example, from (b2), (b3), (b4), (b6), (b7), (b15) and (b16). Of particular note are such compositions wherein the overall weight ratio of component (b) to component (a) is from 30:1 to 1:30 and the weight ratio of component (b5) to component (a) is from 20:1 to 1:10. Included are compositions wherein the weight ratio of component (b5) to component (a) is from 5:1 to 1:5. Examples of these compositions include compositions comprising mixtures of component (a) (preferably a compound from Tables 1-7) with fenpropimorph (b5) and a compound selected from the group consisting of azoxystrobin, epoxiconazole, flusilazole, quinoxyfen, famoxadone, fenamidone, cymoxanil, metalaxyl, benalaxyl, oxadixyl, proquinazid, 6-chloro-2-propoxy-3-propylthieno[2,3-d]pyrimidin-4(3H)-one, folpet, captan and fosetyl-aluminum.

Of note are compositions wherein component (b) comprises at least one compound selected from (b1), for example mancozeb, and at least one compound selected from another component (b) group, for example, from (b2), (b3), (b4), (b5), (b6), (b7), (b15) and (b16). Of particular note are such compositions wherein the overall weight ratio of component (b) to component (a) is from 30:1 to 1:30 and the weight ratio of component (b1) to component (a) is from 10:1 to 1:10. Included are compositions wherein the weight ratio of component (b1) to component (a) is from 10:1 to 1:1. Examples of these compositions include compositions comprising mixtures of component (a) (preferably a compound from Tables 1-7) with mancozeb and a compound selected from the group consisting of famoxadone, fenamidone, azoxystrobin, kresoxim-methyl, pyraclostrobin, trifloxystrobin, cymoxanil, metalaxyl, benalaxyl, oxadixyl, proquinazid, 6-chloro-2-propoxy-3-propylthieno[2,3-d]pyrimidin-4(3H)-one, folpet, captan and fosetyl-aluminum.

Of particular note are a mixture of Compound 1 with azoxystrobin, a mixture of Compound 1 with kresoxim-methyl, a mixture of Compound 1 with dimoxystrobin, a mixture of Compound 1 with fluoxastrobin, a mixture of Compound 1 with picoxystrobin, a mixture of Compound 1 with pyraclostrobin, a mixture of Compound 1 with trifloxystrobin, a mixture of Compound 1 with bromuconazole, a mixture of Compound 1 with cyproconazole, a mixture of Compound 1 with difenoconazole, a mixture of Compound 1 with epoxiconazole, a mixture of Compound 1 with fluquinconazole, a mixture of Compound 1 with flusilazole, a mixture of Compound 1 with hexaconazole, a mixture of Compound 1 with ipconazole, a mixture of Compound 1 with metconazole, a mixture of Compound 1 with propiconazole, a mixture of Compound 1 with prothioconazole, a mixture of Compound 1 with tebuconazole, a mixture of Compound 1 with triticonazole, a mixture of Compound 1 with fenpropidin, a mixture of Compound 1 with fenpropimorph, a mixture of Compound 1 with famoxadone, a mixture of Compound 1 with fenamidone, a mixture of Compound 1 with boscalid; a mixture of Compound 1 with carbendazim, a mixture of Compound 1 with chlorothalonil, a mixture of Compound 1 with dimethomorph, a mixture of Compound 1 with folpet, a mixture of Compound 1 with mancozeb, a mixture of Compound 1 with maneb, a mixture of Compound 1 with quinoxyfen, a mixture of Compound 1 with metrafenone, a mixture of Compound 1 with cyflufenamid, a mixture of Compound 1 with cyprodinil, a mixture of Compound 1 with prochloraz, a mixture of Compound 1 with validamycin, a mixture of Compound 1 with vinclozolin, a mixture of Compound 1 with benomyl, a mixture of Compound 1 with cymoxanil, a mixture of Compound 1 with fosetyl-aluminum, a mixture of Compound 1 with metalaxyl, a mixture of Compound 1 with propineb, a mixture of Compound 1 with zineb, a mixture of Compound 1 with copper sulfate, a mixture of Compound 1 with copper hydroxide, a mixture of Compound 1 with propamocarb, a mixture of Compound 1 with cyazofamid, a mixture of Compound 1 with zoxamide, a mixture of Compound 1 with fluazinam and a mixture of Compound 1 with iprovalicarb. Compound numbers refer to compounds in Table 1.

Of particular note are a mixture of Compound 2 with azoxystrobin, a mixture of Compound 2 with kresoxim-methyl, a mixture of Compound 2 with dimoxystrobin, a mixture of Compound 2 with fluoxastrobin, a mixture of Compound 2 with picoxystrobin, a mixture of Compound 2 with pyraclostrobin, a mixture of Compound 2 with trifloxystrobin, a mixture of Compound 2 with bromuconazole, a mixture of Compound 2 with cyproconazole, a mixture of Compound 2 with difenoconazole, a mixture of Compound 2 with epoxiconazole, a mixture of Compound 2 with fluquinconazole, a mixture of Compound 2 with flusilazole, a mixture of Compound 2 with hexaconazole, a mixture of Compound 2 with ipconazole, a mixture of Compound 2 with metconazole, a mixture of Compound 2 with propiconazole, a mixture of Compound 2 with prothioconazole, a mixture of Compound 2 with tebuconazole, a mixture of Compound 2 with triticonazole, a mixture of Compound 2 with fenpropidin, a mixture of Compound 2 with fenpropimorph, a mixture of Compound 2 with famoxadone, a mixture of Compound 2 with fenamidone, a mixture of Compound 2 with boscalid; a mixture of Compound 2 with carbendazim, a mixture of Compound 2 with chlorothalonil, a mixture of Compound 2 with dimethomorph, a mixture of Compound 2 with folpet, a mixture of Compound 2 with mancozeb, a mixture of Compound 2 with maneb, a mixture of Compound 2 with quinoxyfen, a mixture of Compound 2 with metrafenone, a mixture of Compound 2 with cyflufenamid, a mixture of Compound 2 with cyprodinil, a mixture of Compound 2 with prochloraz, a mixture of Compound 2 with validamycin, a mixture of Compound 2 with vinclozolin, a mixture of Compound 2 with benomyl, a mixture of Compound 2 with cymoxanil, a mixture of Compound 2 with fosetyl-aluminum, a mixture of Compound 2 with metalaxyl, a mixture of Compound 2 with propineb, a mixture of Compound 2 with zineb, a mixture of Compound 2 with copper sulfate, a mixture of Compound 2 with copper hydroxide, a mixture of Compound 2 with propamocarb, a mixture of Compound 2 with cyazofamid, a mixture of Compound 2 with zoxamide, a mixture of Compound 2 with fluazinam and a mixture of Compound 2 with iprovalicarb. Compound numbers refer to compounds in Table 1.

Formulation/Utility

Mixtures of this invention will generally be used as a formulation or composition comprising at least one carrier selected from agriculturally suitable liquid diluents, solid diluents and surfactants. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. The active ingredients can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts (e.g., from 0.01-99.99 weight percent) of active ingredients together with diluent and/or surfactant within the following approximate ranges which add up to 100 percent by weight.

| | Weight Percent | | |
|---|---|---|---|
| | Active | | |
| | Ingredients | Diluent | Surfactant |
| Water-Dispersible and Water- | 5-90 | 0-94 | 1-15 |
| soluble Granules, Tablets | | | |
| and Powders. | | | |
| Suspensions, Emulsions, Solutions | 5-50 | 40-95 | 0-25 |
| (including Emulsifiable | | | |
| Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of Insecticide Dust Diluents and Carriers, 2nd edition, Dorland Books, Caldwell, N.J. Typical liquid diluents are described in Marsden, Solvents Guide, 2nd edition, Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Preferred suspension concentrates include those containing, in addition to the active ingredient, from 5 to 20% nonionic surfactant (for example, polyethoxylated fatty alcohols) optionally combined with 50-65% liquid diluents and up to 5% anionic surfactants. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th edition, McGraw-Hill, New York, 1963, pages 8-57 and following, and World Patent Publication WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE Patent 3,246,493. Tablets can be prepared as taught in U.S. Pat. No. 5,180,587, U.S. Pat. No. 5,232,701 and U.S. Pat. No. 5,208,030. Films can be prepared as taught in GB Patent 2,095,558 and U.S. Pat. No. 3,299,566.

For further information regarding the art of formulation, see U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th edition, Blackwell Scientific Publications, Oxford, 1989.

In the following Examples, all percentages are by weight and all formulations are prepared in conventional ways. “active ingredients” refers to the combination of compounds from group (a) and group (b). Without further elaboration, it is believed that one skilled in the art using the preceding description can utilize the present invention to its fullest extent.

The following Examples are, therefore, to be construed as merely illustrative, and not limiting of the disclosure in any way whatsoever. Percentages are by weight except where otherwise indicated.

### EXAMPLE A

Wettable Powder

| | |
|---|---|
| active ingredients | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### EXAMPLE B

Granule

| | |
|---|---|
| active ingredients | 10.0% |
| attapulgite granules (low volatile matter, | 90.0%. |
| 0.71/0.30 mm; U.S.S. No. 25-50 sieves) | |

### EXAMPLE C

Extruded Pellet

| | |
|---|---|
| active ingredients | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### EXAMPLE D

Emulsifiable Concentrate

| | |
|---|---|
| active ingredients | 20.0% |
| blend of oil soluble sulfonates | 10.0% |
| and polyoxyethylene ethers | |
| isophorone | 70.0%. |

### EXAMPLE E

Suspension Concentrate

| | |
|---|---|
| active ingredients | 20.0% |
| polyethoxylated fatty alcohol | 15.0% |
| ester derivative of montan wax | 3.0% |
| calcium lignosulfonate | 2.0% |
| polyethoxylated/polypropoxylated | |
| polyglycol block copolymer | 1.0% |
| propylene glycol | 6.4% |
| poly(dimethylsiloxane) | 0.6% |
| antimicrobial agent | 0.1% |
| water | 51.9%. |

Compositions of this invention can also be mixed with one or more insecticides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection. Examples of such agricultural protectants with which compositions of this invention can be formulated are: insecticides such as abamectin, acephate, azinphos-methyl, bifenthrin, buprofezin, carbofuran, chlorfenapyr, chlorpyrifos, chlorpyrifos-methyl, cyfluthrin, beta-cyfluthrin, cyhalothrin, lambda-cyhalothrin, deltamethrin, diafenthiuron, diazinon, diflubenzuron, dimethoate, esfenvalerate, fenoxycarb, fenpropathrin, fenvalerate, fipronil, flucythrinate, tau-fluvalinate, fonophos, imidacloprid, indoxacarb, isofenphos, malathion, metaldehyde, methamidophos, methidathion, methomyl, methoprene, methoxychlor, monocrotophos, oxamyl, parathion, parathion-methyl, permethrin, phorate, phosalone, phosmet, phosphamidon, pirimicarb, profenofos, rotenone, sulprofos, tebufenozide, tefluthrin, terbufos, tetrachlorvinphos, thiodicarb, tralomethrin, trichlorfon and triflumuron; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; nematocides such as aldoxycarb and fenamiphos; and biological agents such as Bacillus thuringiensis, Bacillus thuringiensis delta endotoxin, baculovirus, and entomopathogenic bacteria, virus and fungi. The weight ratios of these various mixing partners to compounds of Formula I of this invention typically are between 100:1 and 1:100, preferably between 25:1 and 1:25, more preferably between 10:1 and 1:10 and most preferably between 5:1 and 1:5.

The mixtures and compositions of this invention are useful as plant disease control agents. The present invention therefore further comprises a method for controlling plant diseases caused by fungal plant pathogens comprising applying to the plant or portion thereof to be protected, or to the plant seed or seedling to be protected, an effective amount of a mixtures of the invention or a fungicidal composition containing said mixture.

The mixtures and compositions of this invention provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, vegetable, field, cereal, and fruit crops.

These pathogens include:

Oomycetes, including Phytophthora diseases such as Phytophthora infestans, Phytophthora megasperma, Phytophthora parasitica, Phytophthora cinnamoni, Phytophthora capsici; Pythium diseases such as Pythium aphanidermatum; and diseases in the Peronosporaceae family, such as Plasmopara viticola, Peronospora spp. (including Peronospora tabacina and Peronospora parasitica), Pseudoperonospora spp. (including Pseudoperonospora cubensis), and Bremia lactucae;

Ascomycetes, including Alternaria diseases such as Alternaria solani and Alternaria brassicae; Guignardia diseases such as Guignardia bidwell; Venturia diseases such as Venturia inaequalis; Septoria diseases such as Septoria nodorum and Septoria tritici; powdery mildew diseases such as Erysiphe spp. (including Erysiphe graminis and Erysiphe polygoni), Uncinula necatur, Sphaerotheca fuligena, and Podosphaera leucotricha; Pseudocercosporella herpotrichoides; Botrytis diseases such as Botrytis cinerea; Monilinia fructicola; Sclerotinia diseases such as Sclerotinia sclerotiorum; Magnaporthe grisea; Phomopsis viticola; Helminthosporium diseases such as Helminthosporium tritici repentis; Pyrenophora teres; anthracnose diseases such as Glomerella or Colletotrichum spp. (such as Colletotrichum graminicola); and Gaeumannomyces graminis;

Basidiomycetes, including rust diseases caused by Puccinia spp. (such as Puccinia recondita, Puccinia striiformis, Puccinia hordei, Puccinia graminis, and Puccinia arachidis); Hemileia vastatrix; and Phakopsora pachyrhizi;

other pathogens including Rhizoctonia spp (such as Rhizoctonia solani); Fusarium diseases such as Fusarium roseum, Fusarium graminearum, Fusarium oxysporum; Verticillium dahliae; Sclerotium rolfsii; Rynchosporium secalis; Cercosporidium personatum, Cercospora arachidicola and Cercospora beticola;

and other genera and species closely related to these pathogens.

In addition to their fungicidal activity, the mixtures and compositions can also have activity against bacteria such as Erwinia amylovora, Xanthomonas campestris, Pseudomonas syringae, and other related species.

Of note is use of a mixture of this invention for controlling Erysiphe graminis (wheat powdery mildew), especially using a mixture wherein component (b) is a (b2) compound, e.g., azoxystrobin, a (b4) compound, e.g., flusilazole or a (b5) compound, e.g., fenpropimorph.

Of note is use of a mixture of this invention for controlling Septoria nodorum (Septoria glume blotch), especially using a mixture wherein component (b) is a (b2) compound, e.g., azoxystrobin, a (b4) compound, e.g., flusilazole or a (b5) compound, e.g., fenpropimorph.

Of note is use of a mixture of this invention for controlling Puccinia recondita (wheat leaf rust), especially using a mixture wherein component (b) is a (b2) compound, e.g., azoxystrobin, a (b4) compound, e.g., flusilazole or a (b5) compound, e.g., fenpropimorph.

Also noteworthy is the use of a mixtures or composition of this invention to provide control of diseases caused by a broad spectrum of fungal plant pathogens preventatively or curatively by applying an effective amount of the mixture or composition either pre- or post-infection.

Plant disease control is ordinarily accomplished by applying an effective amount of a mixture of this invention either pre- or post-infection, to the portion of the plant to be protected such as the roots, stems, foliage, fruit, seeds, tubers or bulbs, or to the media (soil or sand) in which the plants to be protected are growing. The mixture can also be applied to the seed to protect the seed and seedling. Typically the mixture is applied in the form of a composition comprising at least one additional component selected from the group consisting of surfactants, solid diluents and liquid diluents.

Rates of application for these compounds can be influenced by many factors of the environment and should be determined under actual use conditions. Foliage can normally be protected when treated at a rate of from less than 1 g/ha to 5,000 g/ha total of active ingredients of groups (a) and (b) in the mixtures and compositions of the present invention. Seed and seedlings can normally be protected when seed is treated at a rate of from 0.1 to 10 g total of active ingredients of groups (a) and (b) per kilogram of seed.

Synergism has been described as “the cooperative action of two components (component (a) and component (b)) of a mixture, such that the total effect is greater or more prolonged than the sum of the effects of the two (or more) taken independently” (see P. M. L. Tames, Neth. J. Plant Pathology 1964, 70, 73-80). It is found that compositions containing the compound of Formula I and fungicides with a different mode of action exhibit synergistic effects.

The presence of a synergistic effect between two active ingredients is established with the aid of the Colby equation (see S. R. Colby, “Calculating Synergistic and Antagonistic Responses of Herbicide Combinations”, Weeds, 1967, 15, 20-22):

$$p = A + B - [ \frac{A \times B}{100} ]$$

Using the method of Colby, the presence of a synergistic interaction between two active ingredients is established by first calculating the predicted activity, p, of the mixture based on activities of the two components applied alone. If p is lower than the experimentally established effect, synergism has occurred. In the equation above, A is the fungicidal activity in percentage control of one component applied alone at rate x. The B term is the fungicidal activity in percentage control of the second component applied at rate y. The equation estimates p, the fungicidal activity of the mixture of A at rate x with B at rate y if their effects are strictly additive and no interaction has occurred.

The following Tests can be used to demonstrate the control efficacy of compositions of this invention on specific pathogens. The pathogen control protection afforded by the compounds is not limited, however, to these species.

Compound 1 is N′-[5-trifluoromethyl-2-methyl-4-[3-(trimethylsilyl)propoxyl]phenyl]-N-ethyl-N-methylmethanimidamide, and Compound 2 is N′-[5-difluoromethyl-2-methyl-4-[3-(trimethylsilyl)propoxyl]phenyl]-N-ethyl-N-methylmethanimidamide. Table 1 further identifies these compounds.

### BIOLOGICAL EXAMPLES OF THE INVENTION

Test suspensions comprising a single active ingredient are sprayed to demonstrate the control efficacy of the active ingredient individually. To demonstrate the control efficacy of a combination, (a) the active ingredients can be combined in the appropriate amounts in a single test suspension, (b) stock solutions of individual active ingredients can be prepared and then combined in the appropriate ratio, and diluted to the final desired concentration to form a test suspension or (c) test suspensions comprising single active ingredients can be sprayed sequentially in the desired ratio.

| | |
|---|---|
| Ingredients | Wt. % |

Composition 1

| | |
|---|---|
| Compound 1 Technical Material | 10.2 |
| Solvents | 59.8 |
| Emulsifiers(s) | 30.0 |

Composition 2

| | |
|---|---|
| Compound 2 Technical Material | 10.2 |
| Solvents | 59.8 |
| Emulsifiers(s) | 30.0 |

Composition 3

| | |
|---|---|
| Flusilazole Technical Material | 26.0-27.0 |
| Solvents | 24.0-25.0 |
| Surfactants | 5.0-6.0 |
| Antifreeze | 2.2 |
| Antifoam | 0.1 |
| Antimicrobial buffer | 0.3 |
| Water | Balance |

Composition 4

| | |
|---|---|
| Azoxystrobin Technical | 25.0 |
| Nonionic surfactant | 10-15.0 |
| Anionic surfactant | 5.0 |
| Rheological modifiers | 5.0 |
| Antifreeze and antifoam | 5-15.0 |
| Water | Balance |

Composition 5

| | |
|---|---|
| Fenpropimorph Technical Material | 73.0-75.0 |
| Solvents and Emulsifiers | 25.0-27.0 |

Test compositions were first mixed with purified water. The resulting test suspensions were then used in the following tests. Test suspensions were sprayed to the point of run-off on the test plants at the equivalent rates of 0.04, 0.2, 1, 5, 20, or 100 g/ha of the active ingredient. The tests were replicated three times and the results reported as the mean average of the three replicates.

### Test A

Wheat seedlings were inoculated with a spore dust of Erysiphe graminis f. sp. tritici, (the causal agent of wheat powdery mildew) and incubated in a growth chamber at 20° C. for 48 h prior to application. The test suspensions were then sprayed to the point of run-off on the wheat seedlings. The following day the seedlings were moved to a growth chamber at 20° C. for 5 days, after which disease ratings were made.

### Test B

The test suspensions were sprayed to the point of run-off on wheat seedlings. The following day the seedlings were inoculated with a spore dust of Erysiphe graminis f. sp. tritici, (the causal agent of wheat powdery mildew) and incubated in a growth chamber at 20° C. for 7 days, after which disease ratings were made.

### Test C

The test suspensions were sprayed to the point of run-off on wheat seedlings. Five days later, the seedlings were inoculated with a spore dust of Erysiphe graminis f. sp. tritici, (the causal agent of wheat powdery mildew) and incubated in a growth chamber at 20° C. for 7 days, after which disease ratings were made.

### Test D

Wheat seedlings were inoculated with a spore suspension of Septoria nodorum (the causal agent of Septoria glume blotch) and incubated in a saturated atmosphere at 20° C. for 48 h. The test suspensions were then sprayed to the point of run-off on the wheat seedlings. The following day the seedlings were moved to a growth chamber at 20° C. for 7 days, after which disease ratings were made.

### Test E

The test suspensions were sprayed to the point of run-off on wheat seedlings. The following day the seedlings were inoculated with a spore suspension of Septoria nodorum (the causal agent of Septoria glume blotch) and incubated in a saturated atmosphere at 20° C. for 48 h, and then moved to a growth chamber at 20° C. for 8 days, after which disease ratings were made.

### Test F

The test suspensions were sprayed to the point of run-off on wheat seedlings. Five days later, the seedlings were inoculated with a spore suspension of Septoria nodorum (the causal agent of Septoria glume blotch) and incubated in a saturated atmosphere at 20° C. for 48 h, and then moved to a growth chamber at 20° C. for 8 days, after which disease ratings were made.

### Test G

Wheat seedlings were inoculated with a spore suspension of Puccinia recondita (the causal agent of wheat leaf rust) 72 hours prior to application and incubated in a saturated atmosphere at 20° C. for 24 h, then moved to a growth chamber at 20° C. for 48 h. The test suspensions were then sprayed to the point of run-off on the wheat seedlings. The following day the seedlings were moved to a growth chamber at 20° C. for 4 days, after which disease ratings were made.

### Test H

The test suspensions were sprayed to the point of run-off on wheat seedlings. The following day the seedlings were inoculated with a spore suspension of Puccinia recondita (the causal agent of wheat leaf rust) and incubated in a saturated atmosphere at 20° C. for 24 h, and then moved to a growth chamber at 20° C. for 7 days, after which disease ratings were made.

### Test I

The test suspensions were sprayed to the point of run-off on wheat seedlings. The following day the seedlings were inoculated with a spore suspension of Septoria tritici (the causal agent of wheat leaf blotch) and incubated in a saturated atmosphere at 20° C. for 72 h, and then moved to a growth chamber at 20° C. for 18 days, after which disease ratings were made.

Results for Tests A to I are given in Table A and B. In the tables, a rating of 100 indicates 100% disease control and a rating of 0 indicates no disease control (relative to the controls). Columns labeled Avg indicates the average of three replications. Columns labeled Exp indicate the expected value for each treatment mixture using the Colby equation. Tests demonstrating substantially greater control than expected are indicated with *.

TABLE A
Test Results (“Avg” is mean rating observed; “Exp” is rating expected from Colby Equation)

| Com- | | | | | | | | | | | | | | | | | |
|---|---|---|---|---|---|---|---|---|---|---|---|---|---|---|---|---|---|
| position | | Test A | | Test B | | Test C | | Test D | | Test E | | Test F | | Test G | | Test H | |
| Number | Rate | Avg | Exp | Avg | Exp | Avg | Exp | Avg | Exp | Avg | Exp | Avg | Exp | Avg | Exp | Avg | Exp |
| 1 | 1 | 43 | — | 0 | — | 39 | — | 0 | — | 0 | — | 0 | — | 0 | — | 0 | — |
| 1 | 5 | 72 | — | 74 | — | 62 | — | 0 | — | 0 | — | 0 | — | 0 | — | 0 | — |
| 1 | 20 | 99 | — | 92 | — | 66 | — | 0 | — | 0 | — | 0 | — | 91 | — | 24 | — |
| 1 | 100 | 100 | — | 100 | — | 98 | — | 88 | — | 100 | — | 94 | — | 100 | — | 100 | — |
| 3 | 1 | 35 | — | 19 | — | 27 | — | 0 | — | 20 | — | 0 | — | 0 | — | 0 | — |
| 3 | 5 | 65 | — | 90 | — | 32 | — | 0 | — | 0 | — | 0 | — | 0 | — | 0 | — |
| 3 | 20 | 100 | — | 99 | — | 16 | — | 0 | — | 67 | — | 0 | — | 19 | — | 16 | — |
| 4 | 0.2 | 21 | — | 0 | — | 16 | — | 13 | — | 65 | — | 0 | — | 0 | — | 16 | — |
| 4 | 1 | 43 | — | 0 | — | 74 | — | 85 | — | 99 | — | 40 | — | 0 | — | 99 | — |
| 4 | 5 | 26 | — | 0 | — | 70 | — | 97 | — | 100 | — | 98 | — | 91 | — | 100 | — |
| 5 | 5 | 21 | — | 0 | — | 86 | — | 33 | — | 0 | — | 0 | — | 0 | — | 0 | — |
| 5 | 20 | 93 | — | 38 | — | 39 | — | 0 | — | 0 | — | 0 | — | 0 | — | 0 | — |
| 5 | 100 | 97 | — | 99 | — | 95 | — | 13 | — | 33 | — | 0 | — | 99 | — | 16 | — |
| 1 + 3 | 1 + 1 | 35 | 63 | 44* | 19 | 43 | 55 | 0 | 0 | 0 | 20 | 0 | 0 | 0 | 0 | 0 | 0 |
| 1 + 3 | 5 + 1 | 73 | 82 | 94* | 79 | 88* | 72 | 0 | 0 | 20 | 20 | 0 | 0 | 0 | 0 | 79* | 0 |
| 1 + 3 | 20 + 1 | 87 | 99 | 99* | 94 | 98* | 75 | 47* | 0 | 93* | 20 | 84* | 0 | 95* | 91 | 100* | 24 |
| 1 + 3 | 1 + 5 | 90* | 80 | 98* | 90 | 33 | 59 | 0 | 0 | 27* | 0 | 0 | 0 | 0 | 0 | 0 | 0 |
| 1 + 3 | 5 + 5 | 99* | 90 | 99* | 97 | 93* | 74 | 0 | 0 | 69* | 0 | 30* | 0 | 41* | 0 | 88* | 0 |
| 1 + 3 | 20 + 5 | 100 | 100 | 100 | 99 | 100* | 77 | 53* | 0 | 96* | 0 | 60* | 0 | 98* | 91 | 100* | 24 |
| 1 + 3 | 1 + 20 | 100 | 100 | 99 | 99 | 62* | 49 | 13* | 0 | 63 | 67 | 0 | 0 | 55* | 19 | 38* | 16 |
| 1 + 3 | 5 + 20 | 100 | 100 | 100 | 100 | 99* | 68 | 27* | 0 | 90* | 67 | 60* | 0 | 92* | 19 | 95* | 16 |
| 1 + 3 | 20 + 20 | 100 | 100 | 100 | 100 | 100* | 71 | 47* | 0 | 97* | 67 | 88* | 0 | 98* | 93 | 100* | 36 |
| 1 + 4 | 1 + 0.2 | 43 | 55 | 44* | 0 | 43 | 49 | 63* | 13 | 78* | 65 | 20* | 0 | 0 | 0 | 79* | 16 |
| 1 + 4 | 5 + 0.2 | 42 | 78 | 85* | 74 | 95* | 68 | 73* | 13 | 94* | 65 | 50* | 0 | 0 | 0 | 99* | 16 |
| 1 + 4 | 20 + 0.2 | 99 | 99 | 100* | 92 | 99* | 71 | 95* | 13 | 98* | 65 | 70* | 0 | 86 | 91 | 100* | 36 |
| 1 + 4 | 1 + 1 | 13 | 68 | 10* | 0 | 64 | 84 | 94* | 85 | 100 | 99 | 60* | 40 | 0 | 0 | 100 | 99 |
| 1 + 4 | 5 + 1 | 73 | 84 | 50 | 74 | 97* | 90 | 99* | 85 | 100 | 99 | 60* | 40 | 55* | 0 | 100 | 99 |
| 1 + 4 | 20 + 1 | 99 | 99 | 98* | 92 | 99* | 91 | 100* | 85 | 100 | 99 | 80* | 40 | 89 | 91 | 100 | 99 |
| 1 + 4 | 1 + 5 | 21 | 58 | 25* | 0 | 73 | 82 | 94 | 97 | 100 | 100 | 97 | 98 | 86 | 91 | 100 | 100 |
| 1 + 4 | 5 + 5 | 84* | 79 | 84* | 74 | 94* | 89 | 99* | 97 | 100 | 100 | 99 | 98 | 91 | 91 | 100 | 100 |
| 1 + 4 | 20 + 5 | 100 | 99 | 99* | 92 | 99* | 90 | 100* | 97 | 100 | 100 | 100* | 98 | 100 | 99 | 100 | 100 |
| 1 + 5 | 1 + 5 | 64* | 55 | 19* | 0 | 93* | 91 | 0 | 33 | 0 | 0 | 0 | 0 | 0 | 0 | 0 | 0 |
| 1 + 5 | 5 + 5 | 98* | 78 | 90* | 74 | 97* | 95 | 53* | 33 | 47* | 0 | 0 | 0 | 55* | 0 | 59* | 0 |
| 1 + 5 | 20 + 5 | 100 | 99 | 99* | 92 | 99* | 95 | 73* | 33 | 93* | 0 | 40* | 0 | 92 | 91 | 100* | 24 |
| 1 + 5 | 1 + 20 | 99* | 96 | 88* | 38 | 74* | 63 | 27* | 0 | 13* | 0 | 0 | 0 | 19* | 0 | 0 | 0 |
| 1 + 5 | 5 + 20 | 100* | 98 | 91* | 84 | 99* | 77 | 27* | 0 | 69* | 0 | 0 | 0 | 80* | 0 | 94* | 0 |
| 1 + 5 | 20 + 20 | 100 | 100 | 99* | 95 | 99* | 79 | 76* | 0 | 94* | 0 | 40* | 0 | 100* | 91 | 100* | 24 |
| 1 + 5 | 1 + 100 | 100* | 98 | 98 | 99 | 98 | 97 | 27* | 13 | 27 | 33 | 0 | 0 | 100 | 99 | 53* | 16 |
| 1 + 5 | 5 + 100 | 99 | 99 | 99 | 100 | 98 | 98 | 90* | 13 | 73* | 33 | 0 | 0 | 99 | 99 | 99* | 16 |
| 1 + 5 | 20 + 100 | 100 | 100 | 100 | 100 | 100* | 98 | 95* | 13 | 99* | 33 | 50* | 0 | 100 | 100 | 100* | 36 |

TABLE B
Test Results (“Avg” is mean rating observed; “Exp” is rating expected from Colby Equation)

| Composition | | Test A | | Test B | | Test C | | Test D | | Test E | | Test F | | Test G | | Test I | |
|---|---|---|---|---|---|---|---|---|---|---|---|---|---|---|---|---|---|
| Number | Rate | Avg | Exp | Avg | Exp | Avg | Exp | Avg | Exp | Avg | Exp | Avg | Exp | Avg | Exp | Avg | Exp |
| 2 | 1 | 20 | — | 83 | — | 92 | — | 0 | — | 0 | — | 0 | — | 0 | — | — | — |
| 2 | 5 | 88 | — | 97 | — | 97 | — | 0 | — | 0 | — | 0 | — | 0 | — | 38 | — |
| 2 | 20 | 99 | — | 99 | — | 100 | — | 27 | — | 80 | — | 70 | — | 86 | — | 67 | — |
| 2 | 100 | 100 | — | 100 | — | 100 | — | 67 | — | 94 | — | 70 | — | 99 | — | 90 | — |
| 3 | 1 | 0 | — | 55 | — | 51 | — | 27 | — | 0 | — | 0 | — | 0 | — | 60 | — |
| 3 | 5 | 100 | — | 99 | — | 99 | — | 47 | — | 0 | — | 20 | — | 41 | — | 44 | — |
| 3 | 20 | 100 | — | 100 | — | 94 | — | 13 | — | 26 | — | 0 | — | 28 | — | 54 | — |
| 4 | 0.04 | 0 | — | 0 | — | 2 | — | 0 | — | 0 | — | 0 | — | 0 | — | 6 | — |
| 4 | 0.2 | 0 | — | 0 | — | 63 | — | 47 | — | 0 | — | 0 | — | 0 | — | 50 | — |
| 4 | 1 | 0 | — | 0 | — | 88 | — | 90 | — | 83 | — | 0 | — | 0 | — | 52 | — |
| 4 | 5 | 0 | — | 0 | — | 46 | — | 90 | — | 99 | — | 78 | — | 0 | — | 50 | — |
| 5 | 5 | 50 | — | 59 | — | 29 | — | 0 | — | 0 | — | 0 | — | 0 | — | 27 | — |
| 5 | 20 | 65 | — | 0 | — | 70 | — | 13 | — | 0 | — | 60 | — | 0 | — | 48 | — |
| 5 | 100 | 100 | — | 98 | — | 2 | — | 0 | — | 0 | — | 0 | — | 97 | — | 42 | — |
| 2 + 3 | 1 + 1 | 0 | 20 | 90 | 92 | 85 | 96 | 13 | 27 | 0 | 0 | 0 | 0 | 0 | 0 | 57 | 60 |
| 2 + 3 | 5 + 1 | 25 | 88 | 99 | 99 | 96 | 98 | 27 | 27 | 0 | 0 | 0 | 0 | 0 | 0 | 59 | 75 |
| 2 + 3 | 20 + 1 | 89 | 99 | 100 | 99 | 100 | 100 | 13 | 46 | 26 | 80 | 0 | 70 | 74 | 86 | 69 | 87 |
| 2 + 3 | 1 + 5 | 100 | 100 | 99 | 99 | 100 | 99 | 0 | 47 | 13 | 0 | 20 | 20 | 28 | 41 | 91* | 44 |
| 2 + 3 | 5 + 5 | 99 | 100 | 100 | 99 | 99 | 99 | 27 | 47 | 0 | 0 | 0 | 20 | 28 | 41 | 98* | 65 |
| 2 + 3 | 20 + 5 | 99 | 100 | 100 | 99 | 99 | 100 | 27 | 61 | 46 | 80 | 0 | 76 | 89 | 92 | 93* | 82 |
| 2 + 3 | 1 + 20 | 100 | 100 | 100 | 100 | 96 | 99 | 33 | 13 | 73* | 26 | 20 | 0 | 94* | 28 | 52 | 54 |
| 2 + 3 | 5 + 20 | 100 | 100 | 100 | 100 | 99 | 99 | 27 | 13 | 76* | 26 | 20 | 0 | 99* | 28 | 61 | 71 |
| 2 + 3 | 20 + 20 | 100 | 100 | 100 | 100 | 100 | 100 | 76* | 36 | 97* | 85 | 70 | 70 | 100* | 90 | 100* | 85 |
| 2 + 4 | 1 + 0.04 | 61 | 20 | 42 | 83 | 19 | 92 | 0 | 0 | 0 | 0 | 0 | 0 | 0 | 0 | 25 | 6 |
| 2 + 4 | 5 + 0.04 | 57 | 88 | 92 | 97 | 97 | 97 | 0 | 0 | 0 | 0 | 0 | 0 | 9 | 0 | 48 | 42 |
| 2 + 4 | 20 + 0.04 | 87 | 99 | 99 | 99 | 99 | 100 | 13 | 27 | 66 | 80 | 0 | 70 | 55 | 86 | 76* | 69 |
| 2 + 4 | 1 + 0.2 | 0 | 20 | 72 | 83 | 91 | 97 | 67 | 47 | 0 | 0 | 50 | 0 | 0 | 0 | 50 | 50 |
| 2 + 4 | 5 + 0.2 | 64 | 88 | 95 | 97 | 99 | 99 | 83* | 47 | 39 | 0 | 40 | 0 | 74 | 0 | 69 | 69 |
| 2 + 4 | 20 + 0.2 | 91 | 99 | 99 | 99 | 100 | 100 | 83* | 61 | 85* | 80 | 20 | 70 | 28 | 86 | 91* | 84 |
| 2 + 4 | 1 + 1 | 0 | 20 | 0 | 83 | 86 | 99 | 93 | 90 | 83 | 83 | 0 | 0 | 19 | 0 | 85* | 52 |
| 2 + 4 | 5 + 1 | 57 | 88 | 84 | 97 | 96 | 99 | 73 | 90 | 88* | 83 | 40 | 0 | 74 | 0 | 79* | 70 |
| 2 + 4 | 20 + 1 | 97 | 99 | 99 | 99 | 100 | 100 | 88 | 93 | 88 | 97 | 0 | 70 | 86 | 86 | 100* | 84 |
| 2 + 4 | 1 + 5 | 0 | 20 | 24 | 83 | 88 | 96 | 85 | 90 | 99 | 99 | 80 | 78 | 9 | 0 | 90* | 50 |
| 2 + 4 | 5 + 5 | 0 | 88 | 92 | 97 | 96 | 98 | 85 | 90 | 99 | 99 | 50 | 78 | 61 | 0 | 98* | 69 |
| 2 + 4 | 20 + 5 | 94 | 99 | 99 | 99 | 99 | 100 | 73 | 93 | 99 | 99 | 50 | 93 | 99* | 86 | 100* | 84 |
| 2 + 5 | 1 + 5 | 73 | 60 | 78 | 93 | 55 | 94 | 0 | 0 | 0 | 0 | 0 | 0 | 0 | 0 | 49 | 27 |
| 2 + 5 | 5 + 5 | 76 | 94 | 97 | 99 | 97 | 98 | 0 | 0 | 0 | 0 | 0 | 0 | 0 | 0 | 59 | 55 |
| 2 + 5 | 20 + 5 | 95 | 99 | 100 | 99 | 100 | 100 | 0 | 27 | 13 | 80 | 60 | 70 | 83 | 86 | 90* | 76 |
| 2 + 5 | 1 + 20 | 86* | 73 | 89* | 83 | 76 | 98 | 0 | 13 | 0 | 0 | 0 | 60 | 0 | 0 | 52 | 48 |
| 2 + 5 | 5 + 20 | 95 | 96 | 99* | 97 | 98 | 99 | 0 | 13 | 0 | 0 | 0 | 60 | 19 | 0 | 69 | 68 |
| 2 + 5 | 20 + 20 | 100 | 99 | 100 | 99 | 100 | 100 | 27 | 36.5 | 88* | 80 | 40 | 88 | 99* | 86 | 86* | 83 |
| 2 + 5 | 1 + 100 | 100 | 100 | 98 | 99 | 51 | 93 | 0 | 0 | 0 | 0 | 0 | 0 | 99* | 97 | 63 | 42 |
| 2 + 5 | 5 + 100 | 100 | 100 | 100 | 99 | 80 | 97 | 0 | 0 | 0 | 0 | 0 | 0 | 100* | 97 | 72* | 64 |
| 2 + 5 | 20 + 100 | 100 | 100 | 100 | 100 | 99 | 100 | 0 | 27 | 69 | 80 | 0 | 70 | 100 | 99 | 88* | 81 |

Table A and B show mixtures and compositions of the present invention demonstrating synergistic control of a wide range of fungal diseases. As control cannot exceed 100%, the unexpected increase in fungicidal activity can be greatest when the separate active ingredient components alone are at application rates providing considerably less than 100% control. Synergy may not be evident at low application rates where the individual active ingredient components alone have little activity. However, in some instances high activity was observed for combinations wherein individual active ingredients alone at the same application rates had essentially no activity. The synergism is indeed highly remarkable. Especially preferred weight ratios where component (b) is a (b2) compound such as azoxxystrobin, to component (a) are from 1:1 to 1:100, more preferably from 1:1 to 1:25. Preferred weight ratios where component (b) is a (b4) compound such as flusilazole, to component (a) are from 1:20 to 20:1, more preferably from 1:5 to 5:1, and most preferably 1:1. Preferred weight ratios where component (b) is a (b5) compound such as fenpropimorph, to component (a) are from 1:1 to 100:1, more preferably from 1:1 to 20:1.

Accordingly, this invention provides a surprisingly improved method of combating fungi, particularly fungi of the classes Ascomycetes, Basidiomycetes, Oomycetes, and Dueteromycetes in crops, especially ornamental, vegetable, field, cereal, and fruit crops.

1. A fungicidal mixture comprising:
(a) at least one compound selected from the phenylamidines of Formula I, N-oxides, and agriculturally suitable salts thereof 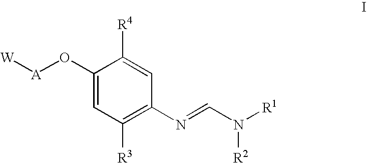
wherein
R¹ is C₁-C₂ alkyl;
R² is C₁-C₃ alkyl or cyclopropyl;
R³ is hydrogen, C₁-C₂ alkyl or halogen;
R⁴ is C₁-C₂ alkyl, C₁-C₂ haloalkyl, methoxy, halomethoxy, C₁-C₂ alkylthio, C₁-C₂ alkylsulfinyl, C₁-C₂ alkylsulfonyl or halogen;
A is C₃ alkylene, optionally substituted with one or two methyl;
W is CR⁵R⁶R⁷ or SiR⁸R⁹R¹⁰; and
R⁵ is hydrogen or C₁-C₃ alkyl optionally substituted with halogen; and
each R⁶, R⁷, R⁸, R⁹ and R¹⁰ is independently C₁-C₃ alkyl optionally substituted with halogen; and
(b) at least one compound selected from the group consisting of
(b1) alkylenebis(dithiocarbamate) fungicides;
(b2) compounds acting at the bc₁ complex of the fungal mitochondrial respiratory electron transfer site;
(b3) cymoxanil;
(b4) compounds acting at the demethylase enzyme of the sterol biosynthesis pathway;
(b5) morpholine and piperidine compounds that act on the sterol biosynthesis pathway;
(b6) phenylamide fungicides;
(b7) pyrimidinone fungicides;
(b8) chlorothalonil;
(b9) carboxamides acting at complex II of the fungal mitochondrial respiratory electron transfer site;
(b10) quinoxyfen;
(b11) metrafenone;
(b12) cyflufenamid;
(b13) cyprodinil;
(b14) copper compounds;
(b15) phthalimide fungicides;
(b16) fosetyl-aluminum;
(b17) benzimidazole fungicides;
(b18) cyazofamid;
(b19) fluazinam;
(b20) iprovalicarb;
(b21) propamocarb;
(b22) validamycin;
(b23) dichlorophenyl dicarboximide fungicides;
(b24) zoxamide; and
(b25) dimethomorph; and
agriculturally suitable salts of compounds of (b1) through (b25).

2. A mixture of claim 1 wherein for component (a) R¹ is methyl or ethyl and R² is methyl, ethyl or cyclopropyl.

3. A mixture of claim 1 wherein component (b) is a compound selected from (b2).

4. A mixture of claim 1 wherein component (b) is a compound selected from (b4).

5. A mixture of claim 1 wherein component (b) is a compound selected from (b5).

6. A mixture of claim 1 wherein component (b) comprises at least one compound from each of two different groups selected from (b1), (b2), (b3), (b4), (b5), (b6), (b7), (b8), (b9), (b10), (b11), (b12), (b13), (b14), (b15), (b16), (b17), (b18), (b19), (b20), (b21), (b22), (b23), (b24) and (b25).

7. A fungicidal composition comprising a fungicidally effective amount of the mixture of claim 1 and at least one additional component selected from the group consisting of surfactants, solid diluents and liquid diluents.

8. A composition of claim 7 wherein component (b) is a compound selected from (b2) and the weight ratio of component (b) to component (a) is from 1:1 to 1:100.

9. A composition of claim 7 wherein component (b) is a compound selected from (b4) and the weight ratio of component (b) to component (a) is from 20:1 to 1:20.

10. A composition of claim 7 wherein component (b) is a compound selected from (b5) and the weight ratio of component (b) to component (a) is from 5:1 to 1:5.

11. A method for controlling plant diseases caused by fungal plant pathogens comprising applying to the plant or portion thereof, or to the plant seed or seedling, a fungicidally effective amount of the mixture of claim 1.

12. A method of claim 11 wherein the component (b) of the mixture is selected from the group consisting of b(2), b(4) and (b5).

13. A method of claim 12 where the fungal plant pathogen is Erysiphe graminis.

14. A method of claim 12 where the fungal plant pathogen is Septoria nodorum.

15. A method of claim 12 where the fungal plant pathogen is Puccinia recondita.

16. A method of claim 12 where the fungal plant pathogen is Septoria tritici.
